(19) United States
(12) Patent Application Publication
(10) Pub. No.: US 2014/0351038 A1
(43) Pub. Date: Nov. 27, 2014

(54) Distribution and Redemption of Coupons Targeted to Mobile Devices

(71) Applicant: Jana Mobile, Inc., San Francisco, CA (US)

(72) Inventors: Benjamin P. Olding, San Francisco, CA (US); Nathan Norfleet Eagle, Boston, MA (US)

(73) Assignee: Jana Mobile, Inc., San Francisco, CA (US)

(21) Appl. No.: 13/902,020

(22) Filed: May 24, 2013

(51) Int. Cl. G06Q 30/02

(52) U.S. Cl. CPC G06Q 30/0225; G06Q 30/0245; G06Q 30/0269
USPC 705/14.26

(57) ABSTRACT

A system and a method for distributing and redeeming coupons through mobile devices of consumers are disclosed. Consumers submit a coupon and purchase proof to the redemption server through mobile devices. Once the purchase information is confirmed, a reward is granted to the consumers along with a survey with questions about consumer demographic information and product related questions. The consumers' answers to the survey questions help target the future coupon distributions.

### CROSS-REFERENCE TO RELATED APPLICATION

This application is related to U.S. patent application Ser. No. 12/848,105, filed Jul. 31, 2010, which is hereby incorporated by reference in its entirety.

### BACKGROUND

This disclosure relates generally to distribution and redemption of coupons for a product to a targeted segment through mobile devices.

Brand marketers often use coupons to introduce new products and to promote sales. Coupons can be distributed to consumers through traditional media, such as snail mails, newspapers, and magazines, or digital media, such as electronic mails and websites. A coupon is usually embedded with a bar code which tells the accepting stores' cashiers what it is for and how much to discount. The bar code is specific to that coupon so it cannot be used for other items. Consumers cut coupons out of newspapers and magazines or simply print them out, and take the coupons to stores. At the point of sale, coupons are scanned and discounts are given to consumers for products that the coupons are meant for. Stores then collect the coupons and forward them to manufacturer for cash returns.

However, developing countries lack the infrastructure to support this kind of coupon distribution and redemption. For example, there may be limited mail and newspaper service and Internet coverage to distribute coupons. Furthermore, retail stores may not be equipped to process coupons at the point of sale.

### SUMMARY

Embodiments of the invention provide coupon redemption and targeted coupon distribution to consumers through their mobile devices. When a merchant is not equipped to process coupons at point of sale during a purchase, a consumer is allowed to redeem a coupon for a product by submitting the purchase information of the product along with the coupon using his or her mobile device after the purchase. The redemption process directs the consumer's mobile device to a coupon server, which validates the submitted purchase information and the coupon. Once the purchase information is validated, the consumer receives a reward associated with the coupon, such as prepaid mobile credits, on his or her mobile device. The consumer may be required to answer a marketing survey for future coupon opportunities.

In one embodiment, to receive a reward (e.g., prepaid mobile credits), a consumer purchases one or more products identified by a coupon and submits unique identifiers of the products to a coupon server. The coupon server verifies the unique identifiers and provides the reward to the consumer along with a marketing survey, which contains demographic and/or product-related questions. The coupon server collects consumer demographic information and/or consumers' answers to the product-related questions to target future coupon distributions and to conduct marketing researches. Consumers who have answered survey questions are selected to receive new coupons based on their demographic information and/or purchase history. The new coupons are transmitted directly to the selected consumers through, for example, text messages, phone calls, emails, tweets, instant messengers. New consumers can be given opportunities to register at the coupon server for future coupon distributions.

### BRIEF DESCRIPTION OF THE FIGURES

FIG. 1 is a high-level block diagram of a communications environment for distributing coupons to mobile devices, according to one embodiment.

FIG. 2 is a block diagram illustrating modules within an exemplary architecture of a coupon server, according to one embodiment.

FIG. 3 is a flowchart illustrating a method for providing a coupon to targeted consumers through mobile devices, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

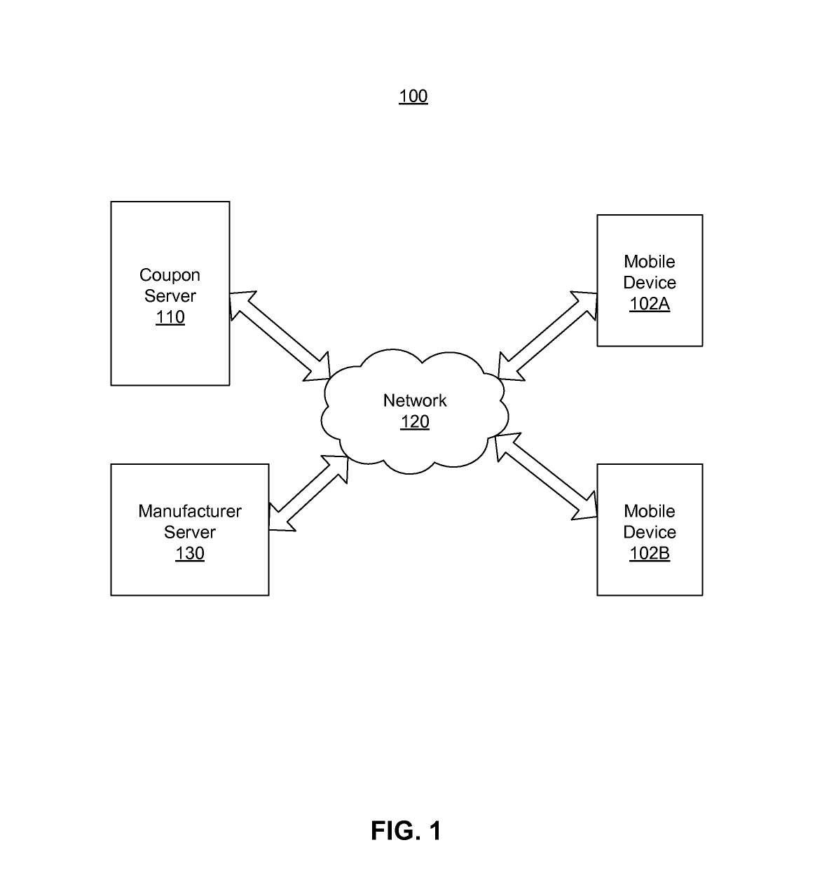

FIG. 1 is a high-level block diagram of a communications environment 100 for distributing coupons to mobile devices. The environment 100 includes multiple mobile devices 102 (depicted by way of example in FIG. 1 as mobile devices 102A and 102B), a coupon server 110, a manufacturer server 130, and a network 120. The network 120 is a data communications network and in one embodiment includes the Internet.

Generally, a manufacturer provides products for sale at various merchants, from which consumers make purchases. To promote its products, the manufacturer may provide coupons directly to consumers or through third party marketers. For example in FIG. 1, the manufacturer server 130 operated by a manufacturer communicates product information and coupon program information to the coupon server 110. The coupon server 110 is operated by the manufacturer or a third party marketer and communicates with the manufacturer server 130. The coupon server 110 also communicates with mobile devices 102 of consumers to distribute coupons to consumers and process coupon redemptions submitted from the consumers' mobile devices 102.

A mobile device 102 is a computing device capable of receiving user input as well as transmitting and/or receiving phone calls and data via the network 120. In one embodiment, a mobile device 102 may be a device having computer functionality, such as a personal digital assistant (PDA), mobile telephone, smart-phone or similar device. The mobile devices 102 are configured to communicate via the network 120. In one embodiment, a mobile device 102 executes an application allowing a user of the mobile device 102 to interact with the coupon server 110. For example, a mobile device 102 executes a browser application to enable interaction between the mobile device 102 and the coupon server 110 via the network 120. In another embodiment, a mobile device 102 interacts with the coupon server 110 through an application programming interface (API) that runs on the native operating system of the mobile device 102, such as IOS® or ANDROID™.

The mobile devices 102 are configured to communicate via the network 120, which may comprise any combination of voice and data networks, using both wired and wireless communication systems. In one embodiment, the network 120 uses standard communications technologies and/or protocols. Thus, the network 120 may include links using technologies such as public switched telephone network (PSTN), Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

A manufacturer server 130 is coupled to the network 120 for communicating with the coupon server 110. In one embodiment, the manufacturer server 130 communicates information describing coupon reward programs provided by the manufacturer to the coupon server 110. The information describing coupon reward programs may include information on the products to which the coupons are designated, such as product identifiers, serial numbers, packaging, distributor and retailers, and manufacturer information, and corresponding coupon information, such as coupon designs, discount values or other rewards, redemption conditions, survey questions, target consumers, validation requirements, and expiration dates. The coupon server 110, on the other hand, communicates with the manufacturer server 130 about consumer profiles and statistics on the coupon reward programs, such as total number of redemptions, percentage of valid and fraudulent claims.

Since a merchant may not be equipped to process coupons at point of sale during a purchase, the coupon server 110 allows a consumer to redeem a coupon for products after the purchase. The consumer can use his or her mobile device to submit the purchase information of the products along with the coupon to the coupon server 110, which verifies purchase information and rewards the consumer accordingly. In one embodiment, the purchase information submitted by the consumer to the coupon server 110 includes unique identifiers of the products with which the coupon is associated. The coupon server 110 verifies the unique identifiers with the product information provided by the manufacturer server 130. If the unique identifiers are valid, the coupon server provides the coupon reward to the consumer.

In one embodiment, the consumer is required to answer a marketing survey as a condition of receiving the coupon reward. Alternatively, the consumer is encouraged to answer the survey for future coupon opportunities. The marketing survey includes demographic and/or product-related questions. The coupon server 110 collects consumer demographic information and purchase history to target future coupon to specific consumers. Consumers' answers to the product-related questions collected by the coupon server 110 can also be used for marketing purposes, such as learning about product distribution channels, consumer feedback, and market visibility (e.g., who is buying and where the products are bought). The use of economic rewards for performing product survey and collecting consumer information can be applied to other “crowdsourcing” jobs, such as distributing multiple discrete tasks to a large group of workers. Providing economic rewards for the performance of tasks by a distributed workforce is described in more details in U.S. patent application Ser. No. 12/848,105, incorporated herein by reference in its entirety.

Consumers can register at the coupon server 110 to start receiving coupons. Those who have registered or taken the survey with the coupon server 110 are selected to receive future coupons based on their demographic information and/or purchase history past behavior. The coupon server 110 transmits instructions for coupon redemption to the mobile devices of those selected consumers via SMS, phone call, emails, tweets, or instant messages. Consumers submit purchase information including identifiers associated with purchased products for coupon redemptions. Again, additional questions about the products or the consumers may be asked at the time of the reward, including information about the merchants.

### Coupon Server Architecture

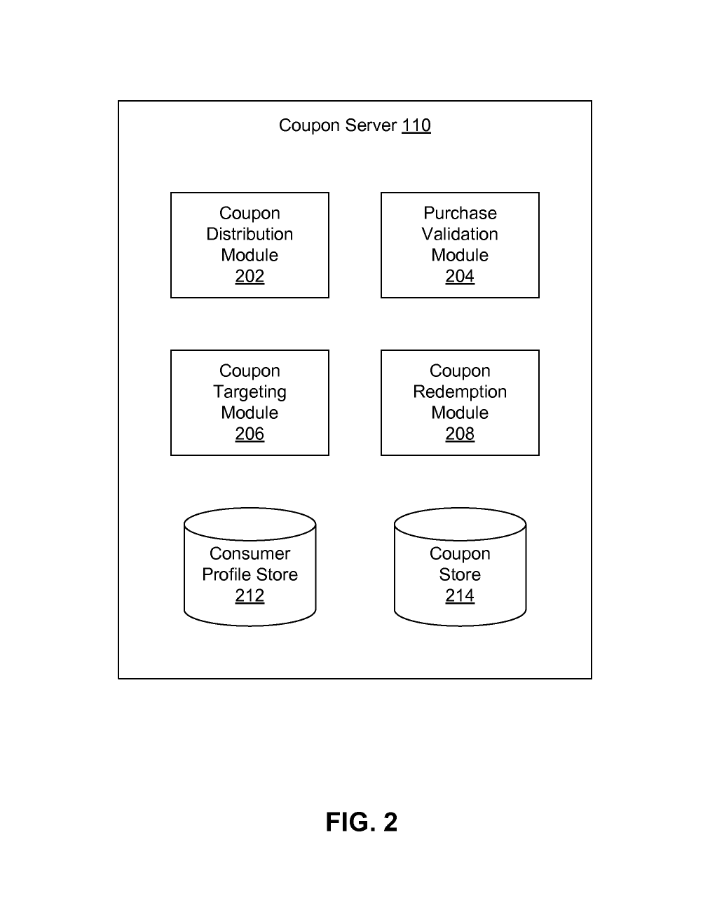

FIG. 2 is a block diagram illustrating modules within an exemplary architecture of the coupon server 110 according to one embodiment. The coupon server 110 includes a coupon distribution module 202, a purchase validation module 204, a coupon targeting module 206, a coupon redemption module 208, a consumer profile store 212, and a coupon store 214. Other embodiments may include different or additional modules. Likewise, the modules may perform different or additional functions in some embodiments.

The coupon distribution module 202 distributes coupons to mobile devices of the consumers. A coupon can be sent to consumers directly via short message service (SMS), instant messages, emails, phone calls, tweets, posts or newsfeeds on social networking systems, or any other messages supported by the consumers' mobile devices. In one embodiment, to bootstrap the coupon promotion, the marketer who operates the coupon server 110 may acquire mobile device numbers from another party, such as mobile service providers, and send out coupons and survey questionnaire to random phone numbers. Upon receiving coupon claims and answers to survey questions from consumers, the consumer information can be collected and stored in the consumer profile store 212. Based on the collected consumer information, the coupon targeting module 206 may later determine a list of target consumers for a coupon and forwards the list of target consumers to the coupon distribution module 202 to send out coupons.

Each consumer is associated with a profile, which is stored in the consumer profile store 212. A consumer profile includes declarative information about the consumer that has received and claimed one or more coupons at the coupon server 110. In one embodiment, a consumer profile includes multiple data fields, each data field describing one or more attributes of the corresponding consumer at the coupon server 110. Examples of information stored in a consumer profile include biographic, demographic, and other types of descriptive information, such as gender, age, address, hobbies or preferences, educational history, work experience, and the like. A consumer profile may also store other information provided by the user, for example, photos or videos. In certain embodiments, photos from consumers may include pictures identifying coupons, proof of purchases, products associated with coupons, stores accepting coupons, and/or consumer themselves. A consumer profile in the consumer profile store 212 may also maintain references to coupons received by the corresponding consumer and coupon redemption events stored in the coupon store 214.

The coupon store 214 stores coupons available to be distributed to consumers, as well as coupon redemption events, such as successful or denied claims from consumers. Coupons may be provided to the coupon server by product manufacturers 130, brand owners, or any other marketing, promotion or advertising agencies on behalf of the manufacturers. Coupons may have expiration date, which is set to target specific consumers or consumer groups based on their demographics and behavior patterns. For example, giving a coupon for a new razor blade expiring in two weeks time to consumers at the time of their purchases of a razor blade can be used to encourage consumer loyalty and more frequent purchase. In one embodiment, the coupon store 214 maintains with each coupon a list of references to consumers that have received the coupon, consumers that have claimed the coupon, and/or consumers that have received the coupon reward or denied of redemption. The coupon redemption claims and results can be associated with each coupon and stored in the coupon store 214.

The purchase validation module 204 validates the coupon submitted by the consumers and verifies the proof of purchase required for the coupon redemption. In one embodiment, to redeem a coupon, a consumer is required to submit proof of purchase to which the coupon is bound. The proof or evidence of purchase includes, for example, an identifier of the product, such as a serial number, a bar code, or a geocode number printed or engrossed on the product itself or on the product package. A first time consumer may be required to submit a unique product identifier in a text message or an email and given an opportunity to register at the coupon server 110. In case for a returning consumer, a unique product identifier may not be necessary, just a bar code or geocode number associated with the product is required for purchase verification. In another embodiment, the consumer may need to answer some detailed questions about the product to prove his purchase. The questions and answers may be conducted via phone calls, online sessions, or interviews in person. In yet another embodiment, the consumers may be required to submit photos of the product and/or pictures of the consumer consuming the product. Other possibilities in submitting evidence of purchase include physically turning in the product packaging or having it altered; for example, punch a hole in the bottle cap or mail in a cap or a sales receipt indicating purchase of the product.

To further limit the possibility of fraud, in one embodiment, the submission of the proof of purchase has to be endorsed by a trusted party, such as the store owner or merchant from which the consumer bought the product associated with the coupon. For instance, the consumer can submit the transaction number, time and date on the receipt together with the product identifier as proof. The purchase validation module 204 may confirm the purchase with the store or the merchant using the transaction number, time and date of the receipt submitted by the consumer. In another embodiment, photographic evidence vouched by trusted source, such as a copy of the receipt, picture of the consumer in front of the store, photo of the store or the store owner, are required for proof of purchase. Furthermore, the purchase validation module 204 may limit the number of times allowed to redeem a certain coupon. For example, a coupon can be redeemed only once by a consumer. To achieve this, the purchase validation module 204 allows exactly one coupon claim from a consumer identified by a unique identifier, such as a national identity card or a mobile device SIM card.

The coupon targeting module 206 determines consumer preferences and purchasing habits based on consumer profile stored in the consumer profile store 212. Based on the consumer preferences and purchasing habits, the coupon targeting module 206 selects a list of target consumers for a certain coupon and provides the list to the coupon distribution module 202, which distributes the coupon to the targeted consumers. Because the coupon distribution targets at consumer preferences and purchasing habits, the consumer is treated more as an individual than as an advertising collective.

In one embodiment, the coupon targeting module 206 selects the target consumer for a coupon based on consumer demographics, psychographics, and product purchase and coupon redemption history stored in the consumer profile store 212 and coupon store 214. The coupon targeting module 206 may also track online or mobile web activities of consumers, such as the content viewed, websites visited, and length of visit by a consumer, and use these traits to target consumers. With targeted coupon distribution, coupons for a product are more likely to reach consumers who have a strong preference for the product, while eliminating “wasted” coupons to consumers whose preferences do not match a product's function. As a result, the targeting of coupon distribution leads to higher chance of redemption and deeper market penetration.

The coupon redemption module 208 communicates with the purchase validation module 204 for coupon redemption. Once a coupon claim is cleared and approved by the purchase validation module 204, the coupon redemption module 208 provides the coupon reward to the consumer who redeems the coupon. A coupon's rewards or discount can be passed to the consumer in various means, for example, through prepaid mobile airtime, electronic money transfer (e.g., PayPal credits), or any form of online e-check. In one embodiment, the coupon redemption module 208 provides future coupon opportunities or additional rewards under the condition that the consumer answers a survey with questions about consumer demographic information and/or questions related to product and purchase. The consumer demographic information and product purchase history are stored in the consumer profile store 212, which provides valuable information to the coupon targeting module 206 to select targeted consumers for various coupons.

In one embodiment, the coupon targeting module 206 and the coupon redemption module 208 may also aggregate the information on consumers and their purchase history and coupon redemptions and transmit the data to the product manufacturers, brand owners, or any third-party entities that facilitate the coupon programs. The product manufacturers and brand owners can analyze the data and study the brand visibility, such as who is buying their product and where the product is bought. The product manufacturers and brand owners may also learn about the distribution channel through which the product moves from information such as merchants or stores where the consumers bought the product.

### Targeted Coupon Distribution

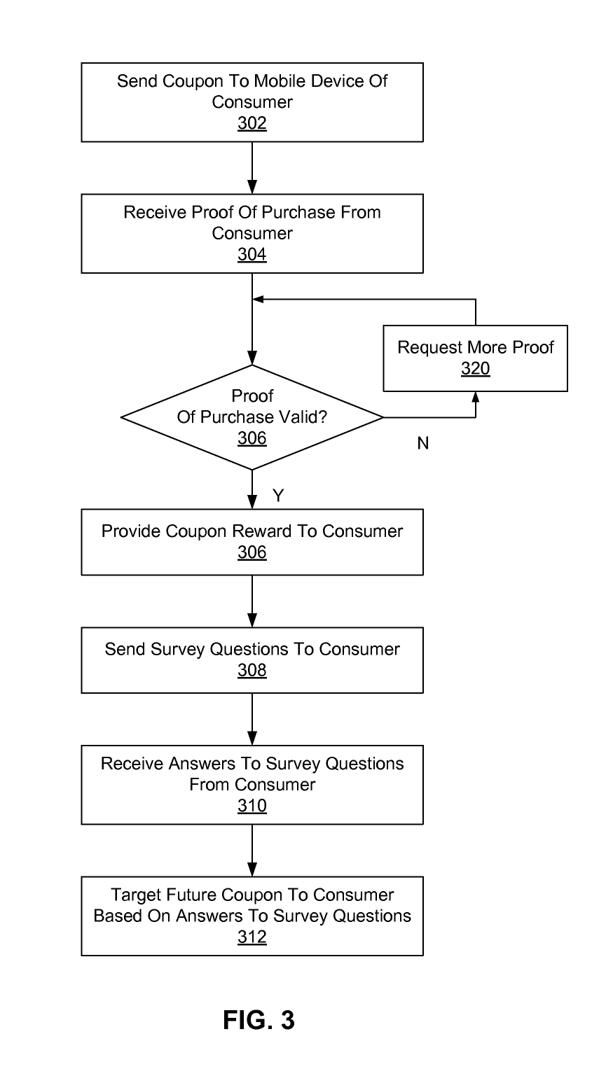

FIG. 3 is a flowchart illustrating a method of providing a coupon to targeted consumers through mobile devices 102 according to one embodiment. In the described embodiment, the steps of the method are performed by the coupon server 110. However, some or all of the steps may be performed by other entities in other embodiments. Likewise, other embodiments may include different and/or additional steps than the ones described herein.

The coupon server 110 first sends 302 a coupon to a mobile device 102 of a consumer. The coupon contains instructions on which product it is to be redeemed and how to redeem the coupon. The coupon can be sent to the consumer via a text message, an email, or a tweet. The consumer may purchase the product for which the coupon is meant and submit a proof of purchase according to the redemption instructions. For example, the consumer may be required to submit a unique identification number found on the packaging of the product or a photo of the product to the coupons server 110. After receiving 304 the proof of purchase from the consumer, the coupon server 110 determines 306 whether the proof of purchase is valid. If the proof of purchase is determined not valid, the coupon server 110 requests 320 more evidence. In one embodiment, the consumer may be allowed to submit evidence of purchase for a couple of iterations before the coupon redemption is denied.

If the proof of purchase is validated, the coupon server 110 provides 306 coupon rewards to the consumer. Examples of coupon rewards provided to consumers include prepaid mobile device air time, electronic payment credit, and future discount opportunity. Next, the coupon server 110 sends 308 a survey to the consumer. In order to receive future coupons, the consumer has to answer demographic and product-related questions. After receiving 310 answers to the survey questions from the consumer, the coupon server 110 can target 312 future coupon distributions to consumers based on collected answers to demographic and product-related questions. For example, the coupon server may target certain coupons to a subgroup of consumers who are most likely to make a purchase based on demographic information or previous purchase history.

In one embodiment, the coupon server 110 requires the consumer to answer the survey questions as a condition of providing coupon reward. In another embodiment, coupon redemption may also be dependent on getting other consumers or merchants (e.g., store owners) to register with the coupon server 110. In yet another embodiment, a group of consumers to purchase products at the same time are given rewards for a coupon. In other embodiments, coupon server 110 provides coupon reward only when the consumer bought different products together, for example, discount given to a purchase of both a razor blade and shaving cream.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, or it may comprise a general-purpose computing device selectively activated or reconfigured by a computer program stored in the computer. Furthermore, any computing systems referred to in the specification may include a single processor or may be architectures employing multiple processor designs for increased computing capability. Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes rather than to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for distributing coupons to targeted consumers, the method comprising:
sending a coupon identifying one or more products to mobile devices of a plurality of consumers;
receiving a proof of purchase for the one or more products identified by the coupon from a consumer;
validating the received proof of purchase for the one or more products;
responsive to a validated proof of purchase, providing coupon reward to the consumers;
sending a survey along with the coupon reward to the consumer, the survey including consumer demographic and products related questions;
receiving answers to the survey questions from the consumer; and
targeting future coupons to selected consumers based on the answers to survey questions collected from the plurality of consumers.

2. The method of claim 1, wherein the coupon is sent to the plurality of consumers by at least one of: short message service (SMS), instant messages, emails, phone calls, tweets, and posts or newsfeeds on social networking systems.

3. The method of claim 1, wherein the proof of purchase includes a unique identifier of the one or more products located on the one or more products or on packaging of the one or more products.

4. The method of claim 3, wherein the unique identifier includes a serial number, a bar code, or a geocode number.

5. The method of claim 1, further comprising requesting photos of the products and/or photos of the consumer consuming the product as proof of purchase.

6. The method of claim 1, further comprising requesting the proof of purchase to be endorsed by a trusted party from which the consumer bought the products identified by the coupon.

7. The method of claim 6, wherein the proof of purchase endorsed by a trusted part includes at least one of: a transaction number of the purchase, time and date of a receipt, a copy of the receipt, picture of the consumer in front of the store, and photo of the store or the trusted party.

8. The method of claim 1, further comprising limiting the number of times allowed to redeem the coupon to a predetermined number.

9. The method of claim 1, wherein the coupon rewards provided to consumers include prepaid mobile device air time, electronic payment credit, and future discount opportunity.

10. The method of claim 1, further comprising selecting a target consumer for a future coupon based on consumer demographics, psychographics, and product purchase and coupon redemption history.

11. A non-transitory computer-readable storage medium storing executable computer program instructions for distributing coupons to targeted consumers, the computer program instructions comprising instructions for:
sending a coupon identifying one or more products to mobile devices of a plurality of consumers;
receiving a proof of purchase for the one or more products identified by the coupon from a consumer;
validating the received proof of purchase for the one or more products;
responsive to a validated proof of purchase, providing coupon reward to the consumers;
sending a survey along with the coupon reward to the consumer, the survey including consumer demographic and products related questions;
receiving answers to the survey questions from the consumer; and
targeting future coupons to selected consumers based on the answers to survey questions collected from the plurality of consumers.

12. The non-transitory computer-readable storage medium of claim 11, wherein the coupon is sent to the plurality of consumers by at least one of: short message service (SMS), instant messages, emails, phone calls, tweets, and posts or newsfeeds on social networking systems.

13. The non-transitory computer-readable storage medium of claim 11, wherein the proof of purchase includes a unique identifier of the one or more products located on the one or more products or on packaging of the one or more products.

14. The non-transitory computer-readable storage medium of claim 13, wherein the unique identifier includes a serial number, a bar code, or a geocode number.

15. The non-transitory computer-readable storage medium of claim 11, further comprising instructions for requesting photos of the products and/or photos of the consumer consuming the product as proof of purchase.

16. The non-transitory computer-readable storage medium of claim 11, further comprising instructions for requesting the proof of purchase to be endorsed by a trusted party from which the consumer bought the products identified by the coupon.

17. The non-transitory computer-readable storage medium of claim 16, wherein the proof of purchase endorsed by a trusted part includes at least one of: a transaction number of the purchase, time and date of a receipt, a copy of the receipt, picture of the consumer in front of the store, and photo of the store or the trusted party.

18. The non-transitory computer-readable storage medium of claim 11, further comprising instructions for limiting the number of times allowed to redeem the coupon to a predetermined number.

19. The non-transitory computer-readable storage medium of claim 11, wherein the coupon rewards provided to consumers include prepaid mobile device air time, electronic payment credit, and future discount opportunity.

20. The non-transitory computer-readable storage medium of claim 11, further comprising instructions for selecting a target consumer for a future coupon based on consumer demographics, psychographics, and product purchase and coupon redemption history.
